(19) United States
(12) Patent Application Publication
(10) Pub. No.: US 2015/0350925 A1
(43) Pub. Date: Dec. 3, 2015

(54) Radio Frequency Space Division Multiplexing

(71) Applicant: Geoffrey Granville Hammett, Norcross, GA (US)

(72) Inventor: Geoffrey Granville Hammett, Norcross, GA (US)

(21) Appl. No.: 14/725,710

(22) Filed: May 29, 2015

Related U.S. Application Data
(60) Provisional application No. 62/005,444, filed on May 30, 2014.

(51) Int. Cl. H04W 16/26; H04B 7/155; H04B 7/06; H04W 16/20

(52) U.S. Cl. CPC H04W 16/26; H04W 16/20; H04B 7/15507; H04B 7/0697; H04W 88/08

(57) ABSTRACT

A wireless network system includes a primary wireless access point (AP) and a first access point node (APN) including a first lighting device with a first integrated wireless access point. The wireless network system further includes a second APN including a second lighting device with a second integrated wireless access point. The first APN and the second APN are wireless network clients to the primary AP and wirelessly communicate with the primary AP. The first APN is configured to wirelessly communicate with a first wireless network client. The second APN is configured to wirelessly communicate with a second wireless network client.

### RELATED APPLICATIONS

The present application claims priority to U.S. Provisional Patent Application No. 62/005,444, filed May 30, 2014, and titled “Radio Frequency Space Division Multiplexing Network Node,” the entire content of which is incorporated herein by reference.

### TECHNICAL FIELD

The present disclosure relates generally to wireless networks, in particular to wireless networks that include lighting devices that serve also as wireless access point nodes/repeaters.

### BACKGROUND

A typical wireless local area network (WLAN) includes an access point (AP). The AP of a WLAN may be coupled to a gateway that interfaces with the internet. The AP may also wirelessly communicate with wireless-capable devices (e.g., laptops, smartphones, printers, etc.) that are part of the WLAN. For example, a wireless-capable device may communicate with other devices that are in the WLAN and access the internet through the AP by wirelessly communicating with the AP.

To have a stable communication between an AP and a wireless-capable device, the AP needs to transmit wireless signals with adequate power for successful reception by the wireless-capable devices of the WLAN. For example, wireless-capable devices that are farther away from the AP may require the AP to transmit the wireless signals at a higher power than other wireless-capable devices that are closer to the AP. However, the amount of power of the wireless signals transmitted by the AP cannot be increased without a limit. For example, increased signal power by the AP may result in signal interference with other communications. Further, increased signal power may undesirably expand the coverage area of the WLAN and result in higher susceptibility to security risks. In addition, maximum power levels are limited by regulations. For example, in the United States, the Federal Communications Commission (FCC) regulates maximum device power, which effectively places caps on wireless signal power levels.

Wireless-capable devices also need to transmit wireless signals to the AP with adequate signal power for successful reception by the AP. A wireless-capable device (e.g., a battery powered device such as a smartphone) that is farther away from the AP than another wireless-capable device may need to transmit wireless signals at higher power than the other wireless-capable device. However, in addition to the limitations discussed above with respect to the AP, transmitting signals with relatively high power may result in undesirably draining battery power of a battery powered device.

Thus, a solution that expands and/or maintains the coverage area of a WLAN while reducing the amount of AP and wireless-capable device signal power needed for successful wireless communication in the WLAN is desirable.

### SUMMARY

The present disclosure relates generally to wireless networks, in particular to wireless networks that include lighting devices that serve also as wireless access point nodes/repeaters. In an example embodiment, a wireless network system includes a primary wireless access point (AP) and a first access point node (APN) including a first lighting device with a first integrated wireless access point. The wireless network system further includes a second APN including a second lighting device with a second integrated wireless access point. The first APN and the second APN are wireless network clients to the primary AP and wirelessly communicate with the primary AP. The first APN is configured to wirelessly communicate with a first wireless network client. The second APN is configured to wirelessly communicate with a second wireless network client.

In another example embodiment, a wireless network system includes a primary wireless access point (AP) and a first lighting device including a first integrated wireless access point. The wireless network system further includes a second lighting device including a second integrated wireless access point. The first lighting device and the second lighting device are wireless network clients to the primary AP and wirelessly communicate with the primary AP. The first lighting device is configured to wirelessly communicate with a first wireless network client. The second lighting device is configured to wirelessly communicate with a second wireless network client.

In another example embodiment, a wireless network system includes a primary wireless access point (AP) and a first access point node (APN) including a first lighting device with a first integrated wireless access point. The wireless network system further includes a second APN including a second lighting device with a second integrated wireless access point. The first APN and the second APN are wireless network clients to the primary AP and wirelessly communicate with the primary AP. The wireless network system further includes a first wireless-capable device and a second wireless-capable device. The first APN is configured to wirelessly communicate with the first wireless-capable device. The second APN is configured to wirelessly communicate with a second wireless-capable device.

These and other aspects, objects, features, and embodiments will be apparent from the following description and the claims.

### BRIEF DESCRIPTION OF THE DRAWINGS

Reference will now be made to the accompanying figures, which are not necessarily to scale, and wherein:

FIG. 1 illustrates a wireless network system including wireless access point nodes according to an example embodiment;

FIG. 2 illustrates the wireless network system of FIG. 1 showing wireless signals transmitted by the access point nodes according to an example embodiment;

FIG. 3 illustrates the wireless network system of FIG. 1 including wireless-capable devices that are network clients of the wireless access point nodes according to an example embodiment;

FIG. 4 illustrates signal power level relative to transmission range according to an example embodiment;

FIG. 5 illustrates lighting devices that can include an integrated wireless access point according to an example embodiment;

FIG. 6 is a block diagram of a wireless access point of an access point node according to an example embodiment; and

FIG. 7 is a block diagram of a wireless access point of an access point node according to another example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, reference numerals designate like or corresponding, but not necessarily identical, elements.

### DETAILED DESCRIPTION OF THE EXAMPLE EMBODIMENTS

In the following paragraphs, example embodiments will be described in further detail by way of example with reference to the figures. In the description, well known components, methods, and/or processing techniques are omitted or briefly described. Furthermore, reference to various feature(s) of the example embodiments is not to suggest that all embodiments must include the referenced feature(s).

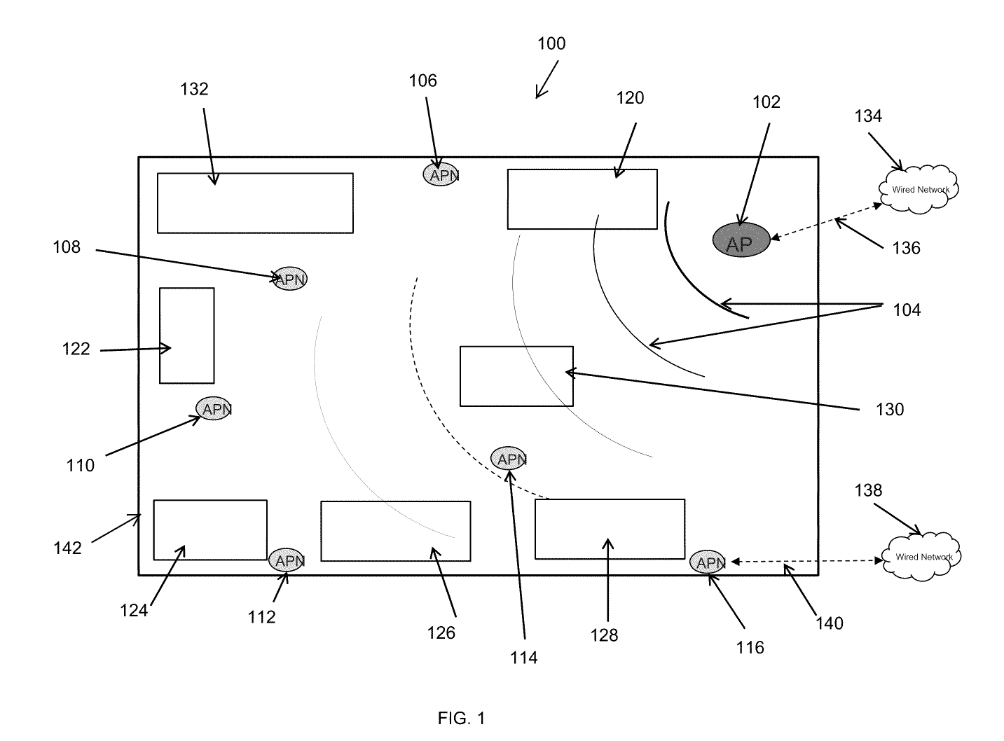

Turning now to the figures, example embodiments are described. FIG. 1 illustrates a wireless network system 100 including wireless access point nodes according to an example embodiment. The system 100 includes a primary access point 102 and access point nodes 106, 108, 110, 112, 114, 116. For example, the primary access point 102 and the access point nodes 106-116 may be located within a building 142. To illustrate, the building 142 may include rooms 120-132 (e.g., offices, conference rooms, etc.). In some example embodiments, the primary access point 102 and the access point nodes 106-116 may be compliant with one or more wireless standards (e.g., IEEE 802.11b/g/n/ac).

In some example embodiments, the primary access point 102 may communicate with the access point nodes 106-116 wirelessly. To illustrate, the access point nodes 106-116 may be wireless network clients to the primary access point 102. For example, the primary access point 102 may allow communication among the access point nodes 106-116 through the primary access point 102. The primary access point 102 may also allow communication between one or more of the access point nodes 106-116 and other networks including the internet.

In some example embodiments, each one of the access point nodes 106-116 may be a lighting device such as luminaire, a receptacle, a switch, sensors, lighting fixture control units, etc. For example, each one of the access point nodes 106-116 may be a lighting device that includes an integrated wireless access point. The integrated wireless access point of each of the access point nodes 106-116 may serve as a wireless access point to wireless-capable devices such as laptops, smartphones, PDA, etc. that are within a coverage area of the respective integrated wireless access point. Thus, each one of the access point nodes 106-116 may be a wireless client to the primary access point 102 while serving as a wireless network access point to other wireless network clients such as smartphones.

In some example embodiments, primary access point 102 may be communicably coupled to a wired network 134 via a wired connection 136. For example, the wired network 134 may include the internet. The primary access point 102 may also communicate with the access point nodes 106-116 using the wireless signals 104. The access point nodes 106-116 may communicate with each other via the primary access point 102 by receiving and processing the wireless signals 104 from the primary access point 102 and transmitting the wireless signals. The access point nodes 106-116 may also communicate with devices that are in the wired network 134 via wireless communication with the primary access point 102.

In some example embodiments, a management device (not shown) may communicate with the access point nodes 106-116 via the primary access point 102. For example, the management device may control (e.g., turn on, off, dim) lighting devices included in the access point nodes 106-116 via the primary access point 102 and the integrated wireless access points integrated with the lighting devices. To illustrate, the management device may send one or more control messages to an integrated wireless access point of one of the access point nodes 106-116 via the primary access point 102. The integrated wireless access point may include or be coupled to circuitry that generates a control signal to control the lighting device of the respective access point node 106-116. The management device may communicate with the primary access point 102 wirelessly or via the wired network.

In some example embodiments, some wireless-capable devices may be farther away from the primary access point 102 than the access point nodes 106-116. For example, the wireless signal power required to reach some the wireless-capable devices may be more than the signal power required to reach the access point nodes 106-116. Thus, because the access point nodes 106-116 are located throughout the building 142 and can serve as wireless access points to wireless-capable devices, the primary access point 102 may transmit the wireless signals 104 to the access point nodes 106-116 at a relatively lower signal power than would be required to transmit to wireless-capable devices that may be farther away from the primary access point 102. Thus, the system 100 may allow the primary access point 102 to operate at lower power than an access point that needs to transmit wireless signals to a larger coverage area.

In some example embodiments, one or more of the access point nodes 106-116 may be connected to a wired network. For example, the access point node 116 may be communicably coupled to the wired network 138 via a wired connection 140.

Although a particular configuration of the primary access point 102 and the access point nodes 106-116 is shown in FIG. 1, in alternative embodiments, the primary access point 102 and the access point nodes 106-116 may be located in a different configuration. Further, in some example embodiments, the system 100 may include fewer or more access point nodes than shown in FIG. 1.

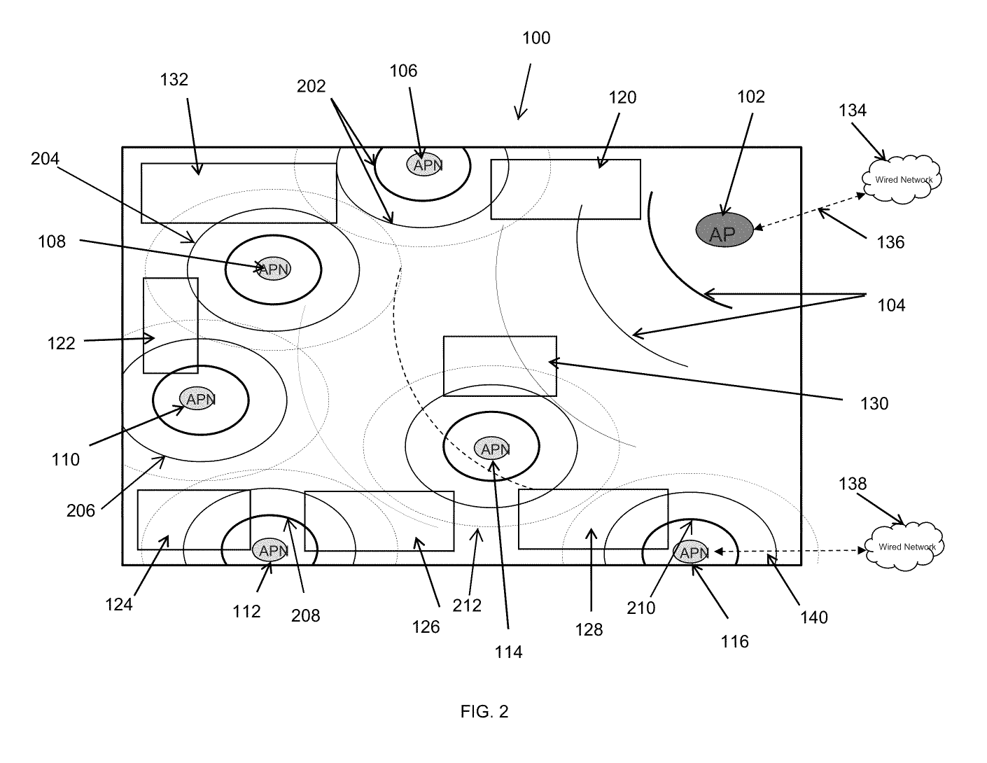

FIG. 2 illustrates the wireless network system 100 of FIG. 1 showing wireless signals 202-210 transmitted by the access point nodes according to an example embodiment. Referring to FIGS. 1 and 2, in some example embodiments, each one of the access point nodes 106-116 may transmit the wireless signals 202-210 to communicate with wireless network clients, such as laptops, smartphones, etc., that are within respective area of the access point nodes 106-116. For example, the access point node 106 may transmit wireless signals 202, and the wireless access point 108 may transmit wireless signals 204. Similarly, the access point node 108 may transmit wireless signals 204, and the access point node 110 may transmit wireless signals 206. The access point node 112 may transmit wireless signals 208, and the access point node 114 may transmit wireless signals 212. The access point node 116 may transmit wireless signals 210.

The primary access point 102 transmits the wireless signals 104 with adequate power to reach the access point nodes 106-116. To communicate with the primary access point 102, the access point nodes 106-116 also transmit wireless signals (not shown) to the primary access point 102 with adequate power to reach the primary access point 102.

The access point nodes 106-116 may transmit the wireless signals 202-210 with relatively lower power than the wireless signal 104. The access point nodes 106-116 also transmit the wireless signals 202-210 with relatively lower power than the signals that the access point nodes 106-116 transmit to the primary access point 102. To illustrate, the wireless signals 202-210 are targeted for wireless network clients (i.e., wireless capable devices) that are within a smaller coverage area (i.e., a cell) as compared to the larger coverage area of the wireless signals 104 transmitted by the primary access point 102. Further, wireless network clients within each cell transmit wireless signals to the respective one of the access point nodes 106-116 with less power than would be required to transmit to the primary access point 102. Because of the lower power of the wireless signals 202-210, interference among the wireless signals 202-210, which are targeted for substantially different cells of a larger area (e.g., a single floor of a building, multiple floors, a large hall, etc.), is lower as compared to interference among stronger signals, such as the wireless signal 104. Because wireless network clients within each cell need to transmit wireless signals with adequate power to reach primarily the respective access point node 106-116 of the respective cell, the number of wireless signals that are transmitted to the primary access point 102 can be significantly reduced. By using the access point nodes 106-116 to communicate to and through the primary access point 102, the number of devices that transmit relatively strong wireless signals is reduced.

In some example embodiments, the access point nodes 106-116 may operate in different wireless channels (frequency) from each other. Alternatively, because of the relatively low signal power of the wireless signals 202-210, some of the access point nodes 106-116 that are physically far from each other may operate in the same wireless channel without significant concern about interference.

By locating the access point nodes 106-116 in different areas of a larger space, the larger space may be divided into smaller cells that are primarily supported by one access point node of the access point nodes 106-116. Because communication between the access point nodes 106-116 and the primary access point 102 may be managed (e.g., multiplexed) based on a communication protocol such as IEEE 802.11 based protocol, wireless-capable devices that are in different cells can communicate to and through the primary access point 102 via a respective access point node of the access point nodes 106-116.

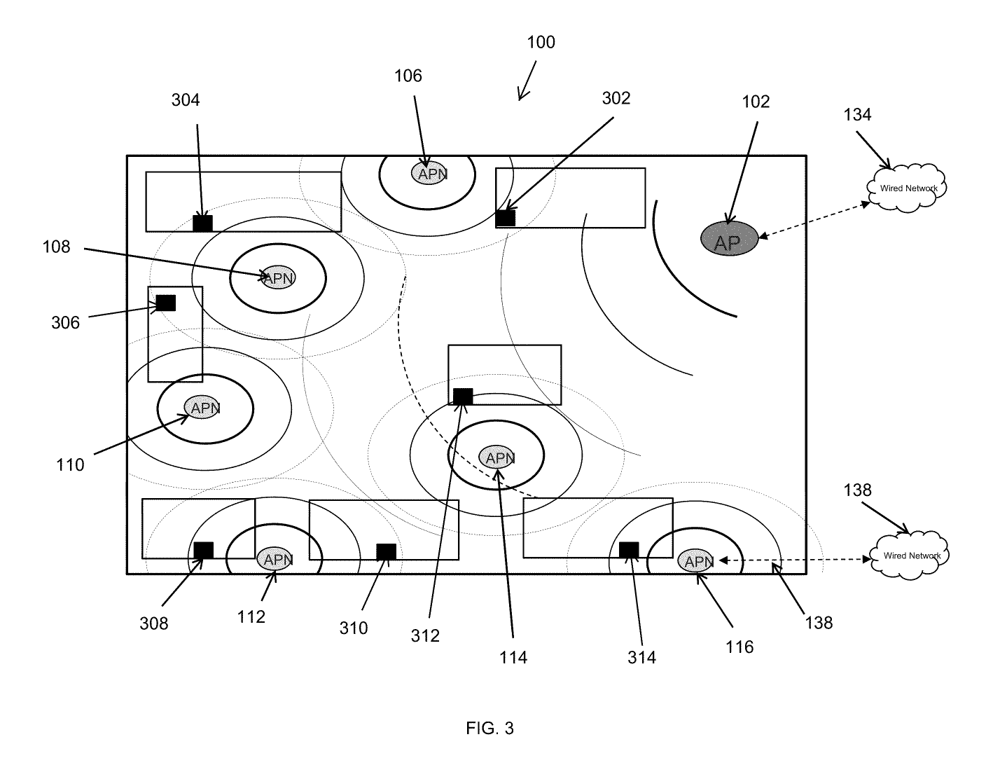

FIG. 3 illustrates the wireless network system 100 of FIG. 1 including wireless-capable devices 302-314 that are network clients of the wireless access point nodes 106-116 according to an example embodiment. Referring to FIGS. 1-3, in some example embodiments, each one of the wireless-capable devices may be a laptop, a smartphone, a tablet, a PDA, a desktop, or any other device that is capable of wireless communication based on a wireless protocol or a wireless standard, such as IEEE 802.11b/g/n/ac and IEEE 802.11a/n/ac. As described above, the access point nodes 106-116 are wireless network clients to the primary access point 102 while the wireless-capable devices 302-314 are wireless network clients to one or more of the access point nodes 106-116. To illustrate, the wireless-capable devices 302-314 may use one of the access point nodes 106-116 as a wireless access point to access other devices on the system or in the wired network 134 via primary access point 102. For example, the wireless-capable device 302 and the wireless-capable device 312 may communicate with each other via the primary access point 102, the access point node 106 and the access point node 114. To illustrate, the wireless-capable device 302 may wirelessly communicate with the access point node 106 and the access point node 106 wirelessly communicates with the primary access point 102, which communicates with the access point node 114. The access point node 114 communicates with the wireless-capable device 312 completing the communication path.

In some example embodiments, the system 100 may include fewer or more wireless-capable devices than shown in FIG. 3. Further, fewer or more wireless-capable devices may be included in each area covered by the access point node 114.

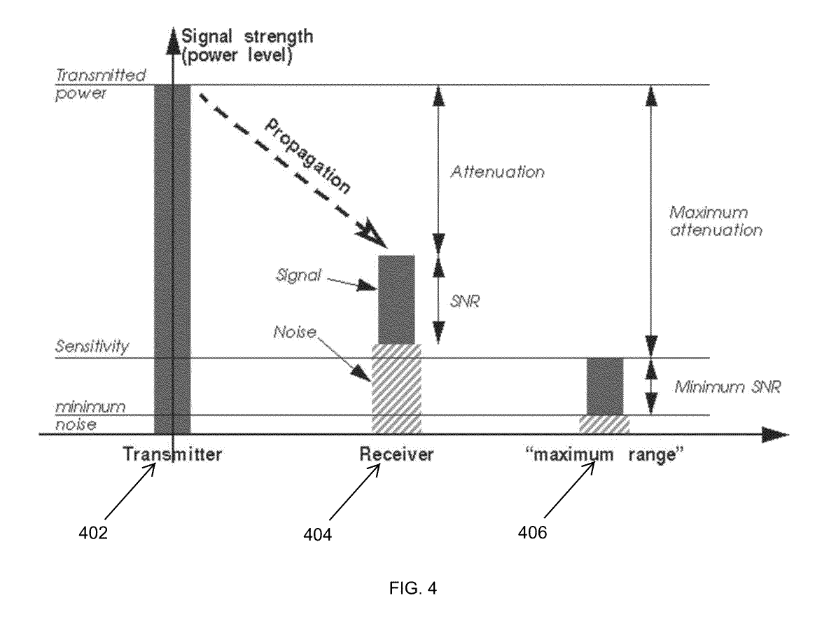

FIG. 4 illustrates signal power level relative to transmission range according to an example embodiment. Referring to FIGS. 1-4, the signal power level of wireless signals, such as the wireless signals 104, 202-214, is typically the highest at the transmitter 402, such as the primary access point 102 and the access point nodes 106-116 when transmitting a wireless signal. At the receiver 404 (e.g., the access point nodes 106-116 and the wireless-capable devices 302-314 when receiving a wireless signal), the wireless signal power is generally attenuated relative to the transmitted power at the transmitter 402. Typically, the power of the wireless signal is attenuated more at locations that are farther away from the transmitter 402 than closer locations. Generally, the wireless signal may be successfully received by a receiver if the signal power remains above a sensitivity threshold, which is affected by many factors including structures between the transmitter 402 and the receiver 404. For example, at a location 406, the signal power of the wireless signal transmitted by the transmitter 402 may be attenuated to the level that is at the sensitivity threshold, and receivers that are farther from the transmitter 402 than the location 406 may not reliably receive and decode wireless signals from the transmitter 402.

Referring to FIGS. 1-4, because the wireless signals 202-214 transmitted by the access point nodes 106-116 and intended for wireless-capable devices 302-314 that are within relative proximity to the respective one of the access point nodes 106-116, the location 406 marking the outer boundary for reliable wireless communication is relatively close to the respective one of the access point nodes 106-116. Accordingly, each one of the access point nodes 106-116 may transmit the respective wireless signals 202-214 at lower power as compared to an access point that needs to transmit wireless signals to network clients that are relatively far. In some example embodiments, the transmit power level of each of the wireless signals 202-214 may be set based on the desired coverage area of the respective one of the access point nodes 106-116.

Table 1 below illustrates the relationship between Effective Isotropic Radiated Power (EIRP), transmit power and antenna gain in accordance to an example embodiment. The FCC generally uses EIRP to determine power limits. As an illustrative example, table 1 shows the combinations of allowed transmit power/antenna gain and the resulting EIRP. For example, EIRP limits may be used to limit the transmit power of the primary access point 102 such that signals transmitted by the primary access point 102 may not be successfully received by a wireless-capable device such as the wireless-capable devices 302-314 of FIG. 3. By transmitting the wireless signal 104 with adequate power to reach an access point node, such as the access point nodes 106-116, that is close to the wireless-capable device, the wireless-capable device may be able to communicate to and through the primary access point 102.

| Transmit Power | Antenna Gain | EIRP |
|---|---|---|
| (dBm) | (dBi) | (dBm) |
| 30 | 6 | 36 |
| 29 | 9 | 38 |
| 28 | 12 | 40 |
| 27 | 15 | 42 |
| 26 | 18 | 44 |
| 25 | 21 | 46 |
| 24 | 24 | 48 |
| 23 | 27 | 50 |
| 22 | 30 | 52 |

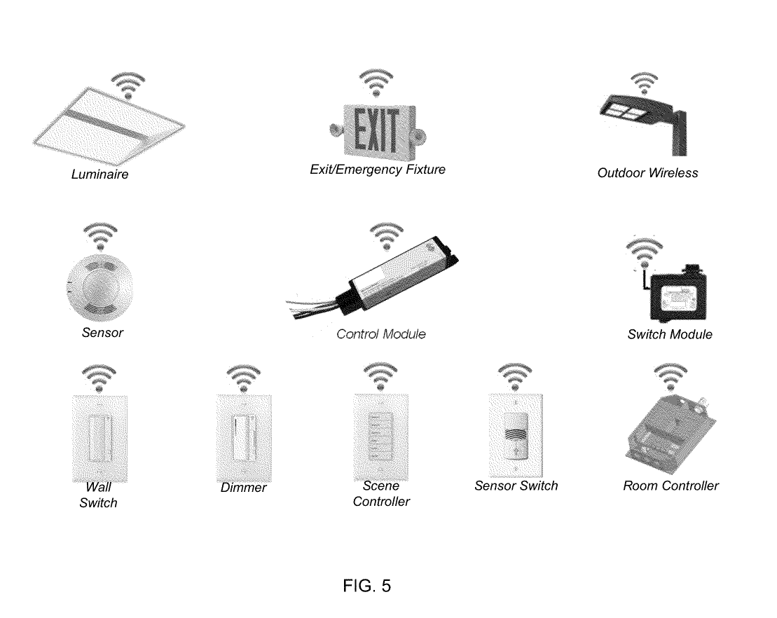

FIG. 5 illustrates lighting devices that can include an integrated wireless access point according to an example embodiment. As a non-limiting example, each one of the access point nodes 106-116 may be an indoor luminaire, an Exit/Emergency Fixture, an outdoor luminaire, a receptacle, a switch, a sensor, lighting fixture control units, a dimmer, etc. that includes wireless access point circuitry.

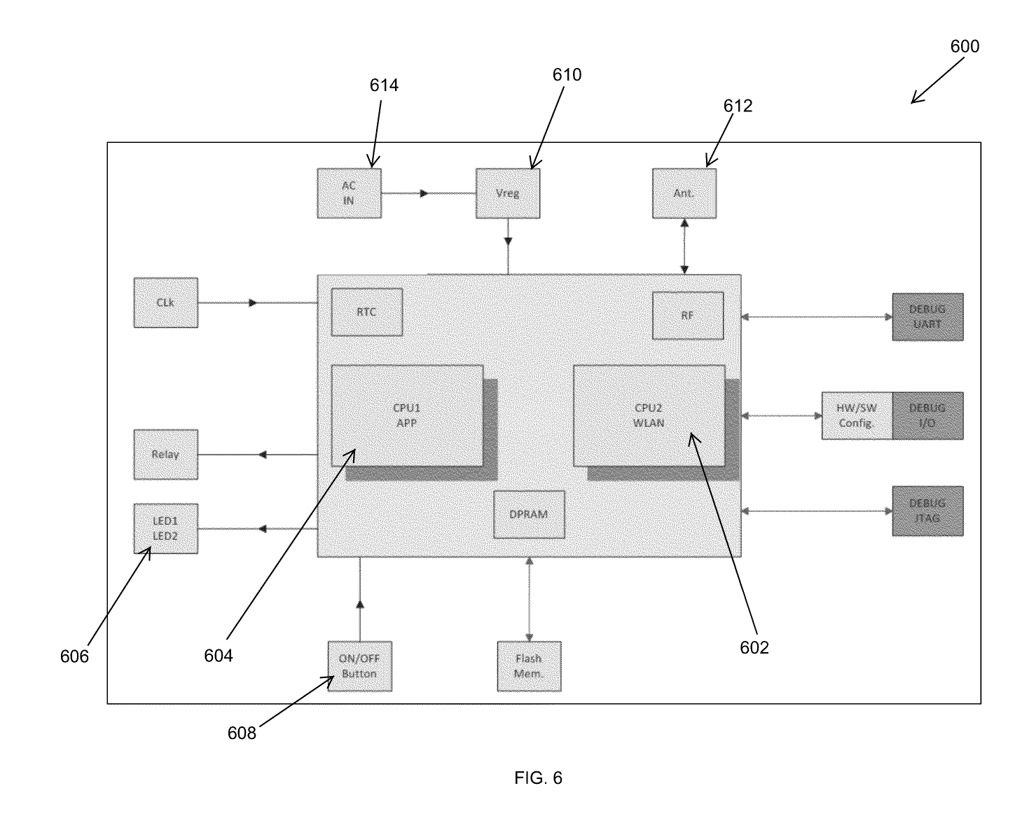

FIG. 6 is a block diagram of a wireless access point 600 of an access point node according to an example embodiment. In some example embodiments, the wireless access point 600 may be integrated in a lighting device, such as the devices illustrated in FIG. 5. For example, the access point 600 may be included in an access point node such as the access point nodes 106-116. As illustrated in FIG. 6, the wireless access point 600 may include processors 602, 604, one or more light emitting diodes (LEDs) 606, and an on/off switch 608. The switch 608 may be used to turn on or off the access point 600 or portions of the access point 600. The LEDs 606 may provide status information such as whether the access point 600 is powered on, transmitting, receiving, etc.

The processor 602 may control wireless communication between the access point 600 and the primary access point 102 FIG. 1. The processor 602 may also control wireless communication between the access point 600 and a wireless-capable device 302-314 of FIG. 3. In some example embodiments, the processor 604 may perform functions such as controlling the respective lighting device of the respective access point node 106-116 that includes the access point 600. The access point 600 may also include an antenna 612 (e.g., internal or external) for transmitting and receiving wireless signals. The wireless signals transmitted by the access point 600 may be compliant with one or more common wireless standards such as IEEE 802.11 based standards.

In some example embodiments, the access point 600 may include a voltage regulator 610 that receives alternating-current (AC) power via power input 614. For example, the regulator 610 may generate direct-current (DC) power that is required for operation of the access point 600. The power input 614 may be coupled to a mains power source or another AC power source.

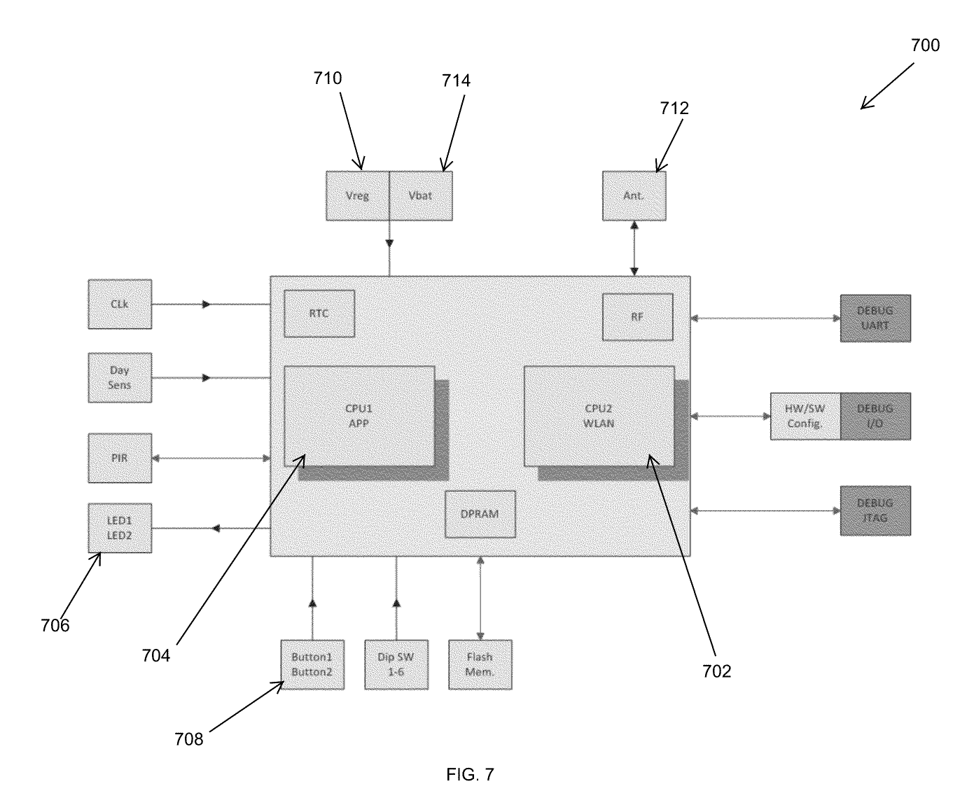

FIG. 7 is a block diagram of a wireless access point 700 of an access point node according to another example embodiment. In some example embodiments, the access point 700 may be integrated in a lighting device, such as the devices illustrated in FIG. 5. For example, the access point 700 may be included in an access point node such as the access point nodes 106-116. As illustrated in FIG. 7, the wireless access point 700 may include processors 702, 704, one or more light emitting diodes (LEDs) 706, and an on/off switch 708. The processor 702 may control wireless communication between the access point 700 and the primary access point 102 FIG. 1. The processor 702 may also control wireless communication between the access point 700 and a wireless-capable device 302-314 of FIG. 3.

In some example embodiments, the processor 704 may perform functions such as controlling the respective lighting device of the respective access point node 106-116 that includes the access point 700. In some example embodiments, the wireless access point 700 may include a voltage regulator 710 (e.g., a DC/DC converter) that generates a DC output from a DC input provided via a DC interface 714. For example, the DC input may be provided from a battery. The access point 700 may also include an antenna 712 (e.g., internal or external) for transmitting and receiving wireless signals. The wireless signals transmitted by the access point 700 may be compliant with one or more common wireless standards such as IEEE 802.11 based standards.

In a system that includes the access point nodes 106-116, which include lighting devices with integrated wireless access points, such as the access point 600, 700, the primary access point 102 may transmit wireless signals to the access point nodes 106-116 at a lower power level than the power level that may be required to directly communicate with some of the wireless-capable devices 302-314. The reduction in the signal power of the wireless signals 104 may result in lower risk of signal interference with wireless signals transmitted by other primary access points that may operate in the same channel of a frequency band. Further, because of the lower power wireless signals transmitted by the access point nodes 106-116 to communicate with the wireless-capable devices 302-314, some wireless communication channels may be re-used in different cells with reduced risk of co-channel interference.

In addition, the access point nodes 106-116 that include wall box mounted switches, dimmers, room sensors and ceiling mounted light fixtures may communicate control information to lighting network elements (i.e., luminaires, etc.) that are included in coverage areas of other access point nodes 106-116 through the primary access point 102. The use of the access point nodes 106-116 can expand coverage of the wireless network, reduce frequency channel overlap and optimize use of limited spectrum. In addition, since the wireless access point nodes 106-116 are closer in proximity to the client wireless-capable devices 302-314, such as a smartphone and tablet that may operate on battery power, the system 100 of FIGS. 1-3 may result in longer battery life for the wireless-capable devices 302-314 as well as improved wireless link.

Although particular embodiments have been described herein in detail, the descriptions are by way of example. The features of the embodiments described herein are representative and, in alternative embodiments, certain features, elements, and/or steps may be added or omitted. Additionally, modifications to aspects of the embodiments described herein may be made by those skilled in the art without departing from the spirit and scope of the following claims, the scope of which are to be accorded the broadest interpretation so as to encompass modifications and equivalent structures.

What is claimed is:

1. A wireless network system, comprising:
a primary wireless access point (AP);
a first access point node (APN) including a first lighting device with a first integrated wireless access point; and
a second APN including a second lighting device with a second integrated wireless access point, wherein the first APN and the second APN are wireless network clients to the primary AP and wirelessly communicate with the primary AP, wherein the first APN is configured to wirelessly communicate with a first wireless network client, and wherein the second APN is configured to wirelessly communicate with a second wireless network client.

2. The wireless network system of claim 1, wherein the primary wireless AP, the first APN, and the second APN are compliant with one or more of IEEE 802.11 standards.

3. The wireless network system of claim 2, wherein the first APN operates in a first channel and wherein the second APN operates in a second channel.

4. The wireless network system of claim 2, wherein the first APN and the second APN operate in same channel.

5. The wireless network system of claim 1, wherein the first APN and the second APN communicate with each other via the primary AP.

6. The wireless network system of claim 1, wherein a first wireless-capable device communicates with the primary AP through the first APN and wherein a second wireless-capable device communicates with the primary APN through the second APN.

7. The wireless network system of claim 1, wherein the first lighting device is controllable via the primary wireless AP.

8. The wireless network system of claim 1, wherein the first lighting device is a luminaire.

9. The wireless network system of claim 8, wherein the first lighting device is controllable via the first integrated wireless access point.

10. The wireless network system of claim 8, wherein the second lighting device is a light switch.

11. A wireless network system, comprising:
a primary wireless access point (AP);
a first lighting device including a first integrated wireless access point; and
a second lighting device including a second integrated wireless access point, wherein the first lighting device and the second lighting device are wireless network clients to the primary AP and wirelessly communicate with the primary AP, wherein the first lighting device is configured to wirelessly communicate with a first wireless network client, and wherein the second lighting device is configured to wirelessly communicate with a second wireless network client.

12. The wireless network system of claim 11, wherein a signal power of a wireless signal transmitted by the primary AP is higher than a signal power of a signal transmitted by the first lighting device.

13. The wireless network system of claim 11, wherein the primary wireless AP, the first APN, and the second APN are compliant with one or more of IEEE 802.11 standards.

14. The wireless network system of claim 13, wherein the first APN operates in a first channel and wherein the second APN operates in a second channel.

15. The wireless network system of claim 13, wherein the first lighting device and the second lighting device are located in different parts of an area and wherein the first APN and the second APN operate in same wireless channel.

16. The wireless network system of claim 11, wherein a first wireless-capable device communicates with the primary AP through the first lighting device and wherein a second wireless-capable device communicates with the primary APN through the second lighting device.

17. A wireless network system, comprising:
a primary wireless access point (AP);
a first access point node (APN) including a first lighting device with a first integrated wireless access point;
a second APN including a second lighting device with a second integrated wireless access point, wherein the first APN and the second APN are wireless network clients to the primary AP and wirelessly communicate with the primary AP;
a first wireless-capable device; and
a second wireless-capable device, wherein the first APN is configured to wirelessly communicate with the first wireless-capable device, and wherein the second APN is configured to wirelessly communicate with a second wireless-capable device.

18. The wireless network system of claim 17, wherein the first wireless-capable device communicates with the second wireless-capable device through the first APN, the second APN, and the primary AP.

19. The wireless network system of claim 17, wherein the first lighting device and the second lighting device are located in different parts of an area and wherein the first APN and the second APN operate in same wireless channel.

20. The wireless network system of claim 17, wherein the first wireless-capable device is a laptop computer or a tablet.
